(19) United States
(12) Patent Application Publication
(10) Pub. No.: US 2018/0362126 A1
(43) Pub. Date: Dec. 20, 2018

(54) HIGH-OUTPUT MULTIFUNCTION SUBMERSIBLE MARINE LIGHTING APPARATUS

(71) Applicant: LIQUID LUMENS, LLC, Salt Lake City, UT (US)

(72) Inventors: Ryan Christensen, North Salt Lake, UT (US); Eric Nofsinger, North Salt Lake, UT (US); Robert D. Christensen, Salt Lake City, UT (US)

(21) Appl. No.: 16/109,480

(22) Filed: Aug. 22, 2018

Related U.S. Application Data
(63) Continuation-in-part of application No. 15/206,190, filed on Jul. 8, 2016.

(51) Int. Cl. B63B 45/02; F21V 13/04; F21V 17/12; F21V 23/04; F21V 29/67; F21V 31/00; F21V 5/04

(52) U.S. Cl. CPC B63B 45/02; F21V 13/04; F21V 17/12; F21V 7/00; F21V 29/67; F21V 31/005; F21V 5/048; F21V 23/0442

(57) ABSTRACT

A submersible marine lighting apparatus is provided that includes voltage up-conversion and that is configured to intensify emitted light by reducing a transmission angle of the light through one or more techniques including increasing the distance between the light emitter and an optical lens.

### CROSS-REFERENCE TO RELATED APPLICATIONS

This application is a continuation-in-part of U.S. patent application Ser. No. 15/206,190 filed on Jul. 8, 2016, entitled “HIGH-OUTPUT MULTIFUNCTION SUBMERSIBLE MARINE LIGHTING APPARATUS,” the entirety of which is incorporated herein by reference.

### BACKGROUND OF THE INVENTION

### Field of the Invention

This invention relates to lighting systems and apparati and in particular, to a submersible marine lighting system and apparatus.

### Description of the Related Art

Submersible lights have been used on ships and watercraft for decorative and functional purposes for decades. Lighting has been applied to decks and hulls of watercraft to improve visibility during the night, to illuminate murky waters, and to shine from a distance.

These marine lighting systems have taken many forms. Thru-hull mounted lights comprising high intensity incandescent light bulbs contained within a housing are known in the art. Light shields to redirect the light rays along the surface of the hull are known.

Numerous aspects of prior art systems include deficiencies or characteristics that are undesirable in many use cases. For example, many marine lighting products are not fully waterproof. This presents issues for lighting designed to be used directly in or in the immediate vicinity of water.

Another issue with prior art marine lighting is that marine lights above the waterline fade rapidly as the light source reaches the waterline.

Some marine lights in the art have been integrated into the hull of a boat watercraft by placing the lights into the thru-hull fittings positioned below the waterline to improve visibility in the surrounding water. By placing the light assembly inside a thru-hull, maintenance can be conducted interiorly to the boat where access is more easily facilitated than outside the boat. However, hull integrity is permanently compromised by the large cylindrical thru-hull frequently required for prior art through-hull mounting systems.

Additionally, traditional marine lighting is static in color and cannot be configured to strobe or flash. Traditional ski boats and pleasure boats operate using 12-volt electrical systems. Such systems do not have the voltage output necessary to optimally power marine lighting with up voltage conversion. Because the output desired by boaters from submersible marine lights is more than can typically be provided by a single marine light at 12 volts, boaters traditionally position a plurality of lights on the hulls of vessels to increase collective output, an inefficiency necessitated by weakness in the art.

With the advent of light emitting diode (LED) based illumination, LED arrays are rapidly replacing incandescent bulbs as preferred illumination sources. Thus, there exists a need in the art for an LED based, submersible lighting system that is affixable to the hulls of boats and that does not compromise the integrity of the hulls. Further, it is desirable to have such systems configurable to shine in any number of colors or flashing patterns and to diffuse higher intensity light than conventional solutions.

Traditional marine lighting applications have also failed to address the need for lighting that can be directionally focused while still maintaining a water proof housing. Current solutions for focused, directional marine lighting are limited above-the-water solutions that require a user to manually aim or point the light in a desired direction. Thus, a need exists in the art for submersible marine lighting that can do more than simply transmit unfocused light that is easily diffused.

Traditional marine lighting applications have also failed to address the need for cooling such apparati in an efficient and elegant manner. For example, some traditional solutions have required housing units that allow water to enter into the internal portion of the housing unit so that the water can directly contact a specific heat sync connected to the light source.

In some prior art solutions, closed loop liquid cooling has also been utilized where an LED array first transmits heat into liquid within a closed tubing system. The tubing system then extends through the waterproof housing containing the LED array where it is then contacted by the environment to dissipate heat. This solution is undesirable because it introduces significant complexity to the cooling system, including introducing additional points of failure where water could be introduced to the LED array area.

Thus, it is apparent that improved submersible marine lighting apparati are needed. The embodiments described herein are not limited to addressing the aforementioned limitations in the art.

### SUMMARY OF THE INVENTION

From the foregoing discussion, it should be apparent that a need exists for a multifunction submersible marine lighting apparatus. Beneficially, such an apparatus would overcome many of the difficulties and concerns expressed above, by providing a multifunction marine lighting apparatus which can be easily installed with multiple lighting functions.

The present invention has been developed in response to the problems and needs in the art that have not yet been fully solved by currently available apparati and methods. Accordingly, the present invention has been developed to provide a submersible light comprising: a base for affixation to a hull of a watercraft, the base defining a recess for receiving an LED array; an LED array; a thermal switch; a plano-convex lens disposed between the base and a retaining ring for focusing light diffusing from the LED array, the plano-convex lens having a circumscribing flange; wherein the retaining ring is bolted to the base.

The apparatus may further comprise a reflector disposed between the plano-convex lens and the base. The retaining ring may be bolted to the base using three flat head screws.

A second submersible marine light is provided comprising: a cylindrical base for affixation to a hull of a watercraft, the base defining a recess for receiving an LED array; an LED array; a thermal switch in logical connectivity with the LED array; a plano-convex lens disposed between the base and a retaining ring for focusing light diffusing from the LED array, the plano-convex lens having a circumscribing flange; a lens gasket disposed between the plano-convex lens and the base; wherein the retaining ring is bolted to the base.

These features and advantages of the present invention will become more fully apparent from the following description and appended claims, or may be learned by the practice of the invention as set forth hereinafter

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1A is a forward elevational side perspective view of submersible marine light in accordance with the present invention.

FIG. 1B is a forward elevational side perspective view of submersible marine light in accordance with the present invention.

FIG. 2 is a lower perspective view of the base in accordance with the present invention.

FIG. 3 is an elevational side perspective view of a convex lens in accordance with the present invention.

FIG. 4 is an elevational side perspective view of a submersible marine lighting apparatus in accordance with the present invention.

FIG. 5 is a side perspective view of a submersible marine lighting apparatus in accordance with the present invention.

FIG. 6 is a top perspective view of a submersible marine lighting apparatus in accordance with the present invention.

FIG. 7 is an exploded environmental side perspective view of a submersible marine light in accordance with the present invention.

FIG. 8 is a block diagram of a fan box for controlling input to a submersible light in accordance with the present invention.

FIG. 9 is a cross-sectional view of a Fresnel style lens that is incorporated in some embodiments of the present invention.

FIG. 10 is a perspective view of a submersible marine lighting apparatus in accordance with the present invention.

FIGS. 11A through 11C illustrate cross sectional views of various configurations of a submersible marine lighting apparatus.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

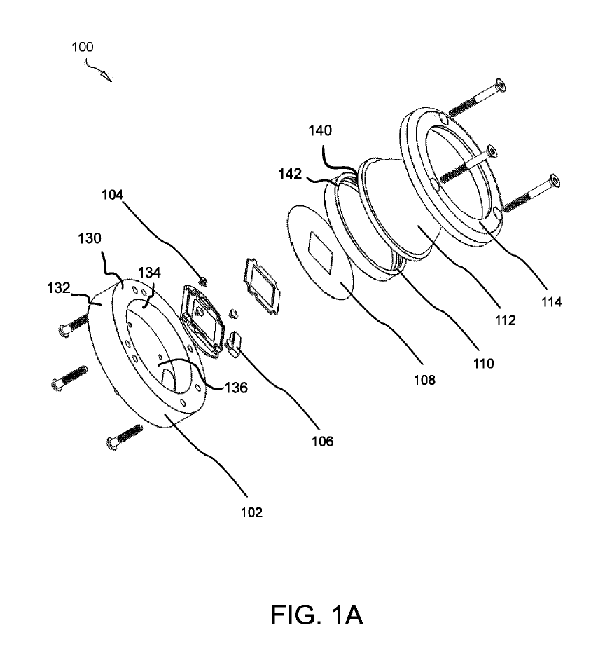

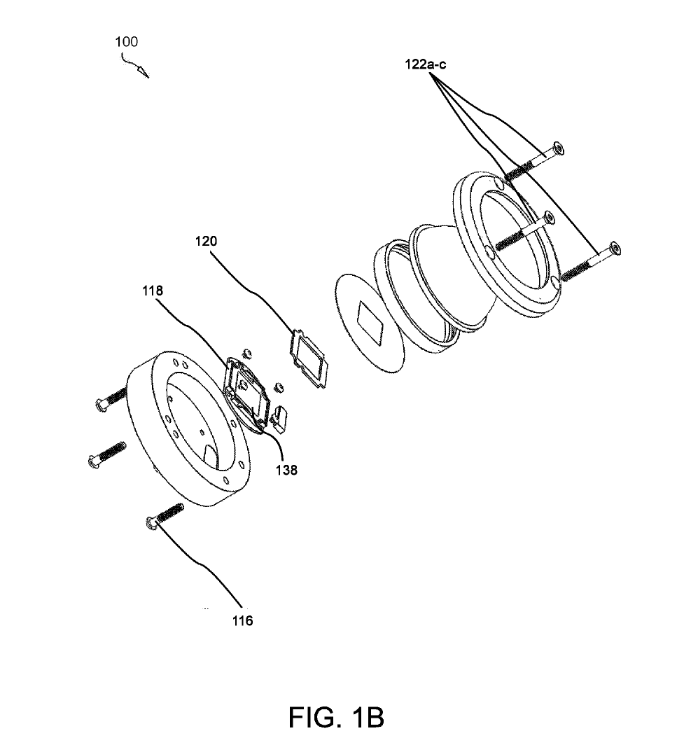

FIG. 1A-1B illustrate forward elevational side perspective views of a disassembled submersible marine light 100 in accordance with the present invention. The light 100 comprises a base 102, a button head cap screw 104, a thermal switch 106, a light reflector 108, a focus lens gasket 110, a focus lens 112, a retaining ring 114, a button head cap screw 116, an LED array 118, a reflector gasket 120, and flat head cap screws 122a-c.

As appreciated by the illustrations, base 102 comprises a cylindrical housing member with a top surface. In some embodiments, the base 102 includes a recess that allows the LED array 118 and thermal switch 106 to be installed within the recess. For example, as illustrated in FIG. 1A, base 102 has a top surface 130, an exterior parameter surface 132, and interior perimeter surface 134, and a recess base surface 136. As illustrated, the height of the interior perimeter surface 134 at least defines the height of the exterior perimeter surface 132.

It is appreciated that base 102 may be comprised of aluminum, stainless steel, titanium, or other materials known to those of skill in the art. It is also appreciated that the material choice selected for base 102 also functions as a conductor to extract heat away from the LED array. For example, rather than requiring the use of an independent heat sync that is attached to the LED array, base 102 is configured such that it both houses LED array 118 and simultaneously functions to conduct heat generated by LED array 118 away from the array into the environment through the surrounding water.

This is particularly beneficial as light 100 is configured to be placed below the water line on the exterior of a watercraft. In so doing, base 102 will be surrounded by water allowing the heat extracted by base 102 from LED array 118 to be conducted into the surrounding water. By utilizing the housing unit directly as a heat sync, the need for other, more complicated, cooling methods are reduced or eliminated. For example, some prior art solutions involve allowing water into a portion of the housing so that it can contact a dedicated heat sync attached to the light source.

Such prior art solutions may be undesirable for several reasons. First, bodies of water in which submersible lighting are used will almost certainly include debris, organic matter, or substances other than simply the water itself. By introducing these pollutants into the housing of the device—particularly to provide the important task of cooling the light source—likelihood of failure is increased.

For instance, a port that allows water to enter the housing to cool the heat sync may become clogged blocking the inflow of new water. Additionally, even if there is no clog, pollutants may become deposited on the interior surface of the housing, including the heat sync, reducing the cooling effect and potentially leading to premature failure of the device.

Accordingly, a base such as base 102 is configured to provide a method of cooling an LED array through direct conduction to the external environment, i.e., the water that the submersible light is surrounded by.

Another primary concern of any submersible lighting apparatus is its ability to remain water tight. While prior art systems that allow some internal portions to directly contact water may be effective in reducing some heat, it also increases the complexity of such designs and introduces additional potential points of failure (e.g., leak points, debris, etc.)

To address these issues, some embodiments of the present invention include providing a direct thermal connection between the LED array 118 and housing 102 such that heat can be passively conducted away from LED array 118, into housing 102, and then directly into the surrounding water.

One having skill in the art would understand that a conductive material may be utilized between the LED array 118 and the base 102. For example, a thermal paste may be utilized to more efficiently conduct heat away from the light source and into the base.

It should also be appreciated that the illustrated device provides a very efficient housing shape for heat management. Unlike prior art systems, a single, substantially circular base is configured such that a single LED array 118 is placed centrally within the base 102. In so doing, heat generated from LED array 118 is most efficiently conducted into housing 102 and then into the surrounding water. It is appreciated that having a dedicated heat sync surrounding each LED array will more efficiently dissipate heat than prior art systems that utilize a bank of LED arrays within a singular housing. For example, some prior art systems utilize a singular rectangular housing with rows of lights inside the rectangle. Such a shape will less efficiently dissipate heat.

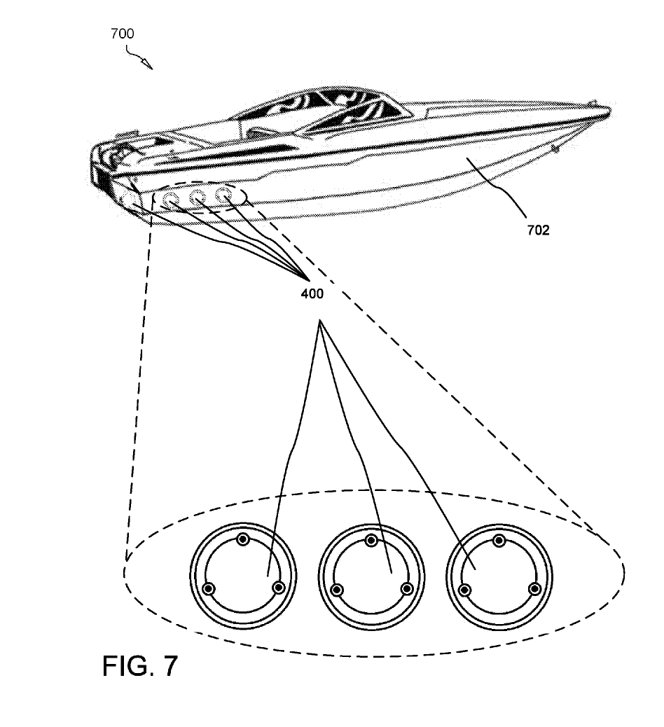

The shape of base 102 also allows light 100 to be placed in locations on a water craft that prior art solutions would be ill suited for based on their physical shape and size. For example, as illustrated in FIG. 7, light(s) 100 may be placed on the side of a watercraft.

Because base 102 is circular, the water drag across light 100 is minimal, particularly as compared to prior art solutions that are often large rectangular banks of lights. Additionally, because base 102 functions as both the housing and the heat sync, the overall distance light 100 protrudes away from the hull of the water craft is reduced as compared to prior art systems.

Further, in scenarios such as the one described above, when light 100 is positioned in a location where water drag is an issue (e.g., on the side of a hull), there is increased concern that water may be forced into portions of the light 100 that need to remain water tight.

As will be appreciated, the size (both depth and diameter) of the recess within base 102 allows for placement of the LED array and other components in light 100 in different positions relative to the other components of light 100. As one non-limiting example, a base 102 with a recess height of between 10 mm and 25 mm may result in a light 100 with an LED array 118 installed in a location that is closer to other components, for instance focus lens 112, than would an LED array 118 in a different base with a 25 mm to 50 mm recess height. This is possible because, in various embodiments, the base 102 in bored, drilled or otherwise configured to define a plurality of tapped threaded apertures for receiving threaded ends of flat head cap screws or button head cap screws.

Using these attachment points, elements such as LED array 118 and thermal switch 106 can be securely mounted inside base 102 and in a desirable location relative to the top surface 130 of base 102. It is also appreciated that to maintain a water tight enclosure, in some embodiments the attachment points do not extend entirely through the recess base surface 136.

The LED array 118 may comprise chip on board (COB). In various embodiments, the COB LED array 118 is powered by 24-volt nominal, 36-volt nominal, 48-volt nominal, 60-volt nominal, or other higher nominal voltage input, to produce optimal light output from the light 100. Twelve-volt boat, watercraft or vessels electrical systems may be converted upwards using means known to those of skill in the art, including transformers, converters, boosters, and the like. In various embodiments, the light 100 is powered by a separate fan box 800 (further described below).

It is appreciated that the aforementioned operating voltages are non-limiting and are expressed in nominal values to account for the fact that different LED arrays may operate at slightly different preferred voltages. For example, a 24-volt nominal LED array may operate within a range of anywhere between 20 volts to 28 volts. Similarly, a 36-volt LED array may operate in a range such as 33 volts to 40 volts, depending on the configuration. As such, one having ordinary skill in the art would recognize that nominal values function as a rough approximation of the type of LED array and should not be interpreted as limiting the invention to configurations that operate only at those specific voltages.

In some embodiments light output from the light 100 is further amplified (or focused) using the focus lens 112 which directs light diffused from the LED array 118 into a more focused beam emitting from the focus lens 112.

This ability to focus the light emitted by the LED array greatly improves some applications of light 100. As described above, focusing may be accomplished using a focusing lens, such as focus lens 112, that is manufactured to collect light from LED array 118 and focus the light according at a desired transmission radius. In other embodiments, focusing may be accomplished by altering the physical distance between the lens and the transmission surface 138 of LED array 118.

Whether light focusing is accomplished using a focusing lens or by increasing the instance between the lens and the light source (or through a combination of methods), it is helpful to understand and describe the mathematical principles behind the focusing effect.

For example, in an embodiment where light 100 is placed below the waterline, transmitted light quickly diffuses in all directions away from the hull. Mathematically, the three-dimensional space in which light diffuses from a single point source is measured in steradians (i.e., three dimensional radians.) As the transmission angle of a point light at a given lumen output is decreased (e.g., becomes narrower, or more focused) the intensity of the transmission is increased. The intensity of such focusing is mathematically described in candela units.

It should be appreciated that the mathematical calculations discussed herein are included only to describe general principles rather than to calculate any required parameters of the present invention. However, by understanding the effect that certain alterations to described exemplary embodiments of the present invention, one having skill in the art would be able to understand the types of configurations that would achieve the disclosed benefits and improvements over existing solutions.

The following equation describes a relationship between transmission volume “lm” (i.e., lumens), transmission intensity “cd” (i.e., candela), and the degree of transmission angle (i.e., steradians).

$$cd = \frac{lm}{2 π ( 1 - cos ( \frac{{deg}^{°}}{2} ) )}$$

Utilizing the equation above, and assuming a 1000 lumen output LED array, a light transmission from a single hemi-spherical point light transmission source (e.g., light 100 transmitting light uniformly at 180 degrees through a plano-convex lens) would produce output of 160 candela.

However, by reducing the transmission angle (e.g., focusing the transmitted light), the intensity of the light beam is increased without altering the lumen output of the transmission source (e.g., LED array 118.) For example, if focus lens 112 is configured to reduce the transmission angle from 180 steradians (e.g., 180 degrees in three-dimensional space or a full hemisphere) to 120 steradians, the intensity of the focused light increases to approximately 318 candela. Thus, as is appreciated by the forgoing example, reducing the transmission angle by one third (i.e., 180 steradians to 120 steradians) results in almost doubling the intensity of the light beam (i.e., 160 candela to 318 candela.)

Thus, to increase the intensity of the output of light from light 100, the light is focused to thereby reduce the transmission angle of light exiting the apparatus. Depending on the embodiment, this focusing is accomplished using one or more techniques.

As described above, in one embodiment, light 100 may be configured to transmit light evenly across 180 steradians. This may be accomplished by placing the transmission surface, for example transmission surface 138 of FIG. 1B, of LED array 118 so that it is substantially coplanar with surface 130 of based 102. By placing LED array 118 in this position, substantially all light produced by the array is transmitted evenly in all directions into the surrounding environment. Notably, in this embodiment, reflector 108 functions to ensure that light that is internally reflected (e.g., by lens 112) is not entirely lost but is redirected to exit the apparatus.

In another embodiment, LED array 118 is offset within base 102 in a position that places the transmission surface 138 of the array somewhere behind top surface 130 of base 102 (e.g., behind being designated as toward the bottom of base 102 and away from the lens.) In so doing, the transmission angle of LED array 118 is not a full 180 steradians as in the previous example but is some number less than 180 steradians, depending on the offset distance.

This reduction in transmission angle results in a more focused light beam exiting the apparatus. As discussed in conjunction with the candela formula above, because the transmission power of the LED array 118 has not been altered but the transmission angle has been reduced, the intensity of the focused beam is increased (i.e., the candela value is increased.)

Thus, in one embodiment, a light 100 is configured such that the inner diameter of the recess of base 102 at the top surface 130 is approximately 150 mm. Notably, the height of the interior of the recess may be uniform, or it may be some other shape such as a tapered shape or a conical shape.

For the sake of understanding the resultant light intensification that occurs from modifying the distance between LED array 118 and the lens, a primary variable is the aperture of the opening through which transmitted light passes prior to reaching the lens. To approximate that modified transmission angle, trigonometry can be utilized using the offset distance between the LED array surface and the bottom of the lens (approximated, in this example, as being the same as the inner diameter of the recess of base 102 at the top surface 130 onto which the lens is mounted.)

Continuing with this example, LED array 118 is located within base 102 such that the transmission surface 138 of the LED array is about 12.5 mm below top surface 130 of base 102. This may be accomplished, for example, by increasing the height of exterior surface 132 of base 102 such that interior surface 130 has a height of 12.5 mm plus the thickness of LED array 118 and necessary mounting hardware.

Finally, a lens is attached to base 102 such that the diameter of the base of the lens approximately matches the recess diameter of 150 mm. As illustrated, the lens may also include a flange in order to secure it to base 102 in a suitable manner.

According to this described embodiment, the transmission angle would be reduced from 180 steradians (e.g., when the surface of the LED array is coplanar with top surface 130) to about 160 steradians. Accordingly, the candela measurement for this embodiment would be increased from about 160 candela to about 190 candela.

For the sake of additional illustration of the effect of increasing the distance between the LED array 118 and the lens, in a second embodiment the surface of the LED array 118 is located within base 102 such that it is offset approximately 25 mm rearward from top surface 130. Assuming all other factors remain the same from the previous example, the transmission angle would be reduced to about 143 steradians (as compared to 160 in the prior example) increasing the output to about 233 candela (as compared to 190 candela in the prior example.)

As can be appreciated by the foregoing, non-limiting, examples, by configuring light 100 to allow placement of LED array 118 at different distances from top surface 130, the output characteristics of light 100 can be modified to produce different focusing characteristics with desirable candela values.

In other embodiments, base 102 may remain constant, but other aspects of light 100 may be altered. For example, focus lens gasket 110 may be configured such that focus lens 112 is farther from the transmission surface 138 of LED array 118. In such embodiments, the aforementioned focusing of light (and corresponding candela increase) from LED array 118 is still accomplished but done in a manner that utilizes a uniform base 102.

In another embodiment, a combination of placing the LED array transmission source farther inside base 102 and extending the distance of a lens farther from the LED array may be utilized. For example, in an embodiment, LED array 118 is placed 12.5 mm from top surface 130 into base 102 while focus lens gasket 110 is configured to place focus lens 112 about 12.5 mm from top surface 130. As can be appreciated, the combination of these configurations places the transmission surface 138 of LED array 118 approximately 25 mm from the bottom surface of lens 112, effectively producing the same focusing effect previously described.

In some embodiments, light 100 may be configured in a manner that allows the distance between the transmission surface 138 of LED array 118 and the bottom surface of a lens, such as focus lens 112 to be adjustable. For example, in some embodiments, focus lens gasket 110 may be configured such that it can be rotated. As illustrated, focus lens gasket 110 may include internal threading 140 and flange 142.

As one having ordinary skill in the art would recognize, internal threading 140 could then be configured such that as focus lens gasket 110 is rotated, focus lens 112 is caused to be moved closer or farther from base 102 depending on the rotation direction. In this manner, light 100 may be adaptable to different situations that benefits from greater light intensity (e.g., higher candela values) by increasing the distance between the transmission surface 138 of LED array 118, or for broader light diffusion when the distance is reduced.

In other embodiments, focus lens gasket 110 includes one or more fixed retaining grooves that are configured to receive a flange on focus lens 112. In such a configuration, rather than rotating focus lens gasket 110 to dynamically modify the distance between the lens and the LED array, the lens can be fixed in place within one of the retaining grooves. While this perhaps limits the dynamic adjustability of light 100, such fixed retaining grooves may increase the reliability of light 100 by more positively positioning focus lens 112 at a preconfigured distance from the LED array.

In one corresponding embodiment, focus lens 110 may include multiple retaining grooves positioned a known distance apart, for example 5 mm each. Accordingly, the distance between focus lens 112 and the LED array can be adjusted in 5 mm increments to increase or decrease light focusing depending on the current application of light 100.

Similarly, as would be appreciated by one having ordinary skill in the art, cap screws 104 that are used to secure LED array 118 to base 102 may also be adjustable such that LED array 118 can be moved in relation to focus lens 112. In some embodiments, cap screws 104 may be accompanied by standoff mounts that can be positioned between the LED array assembly and the mounting surface of base 102. In this manner, the offset distance between the LED array 118 and the lens can be modified in a simplified manner using the mounting hardware rather than directly modifying the housing itself.

It should be apparent from the forgoing that while a higher output LED array would alone improve the present invention over the prior art by providing a higher output light 100 (e.g., thus eliminating the need to affix multiple lights to a hull surface) because of the candela effect and the ability to adjust the spatial relationship between LED array 118 and a lens, lower power LED arrays can be utilized while maintaining sufficiently powerful transmission beams.

For example, using the formula discussed previously, one can identify that an LED array outputting 1000 lumens focused to 160 steradians produces a focused light transmission at approximately 193 candela. However, in some embodiments, a 1000 lumen LED array may be undesirable because it draws too much power, produces too much heat, is too expensive to manufacture, or is physically too large for the desired housing size. Whatever the reason, an LED array that generates less light volume (e.g., outputs a lower lumen rating) may be utilized by reducing the transmission angle by focusing the light using one of the techniques previously discussed.

Accordingly, while a 1000 lumen LED array produces 193 candela at 160 steradians, an 800 lumen LED array is capable of producing the same intensity by focusing the light transmission to 140 steradians. In practice, this represents only 10 degrees of reduced transmission in each direction in the horizontal plane while allowing for an LED array that outputs 20% less light and requires less power.

In order to utilize the reduced output LED, light 100 must be able to accommodate increasing the distance between the LED array and the lens, as described previously. For the sake of completeness, in the scenario described reducing the LED array from 1000 lumens to 800 lumens (while maintaining approximately 193 candela), the 800 lumen LED array must be offset approximately 14 mm more from the lens than the 1000 lumen LED array.

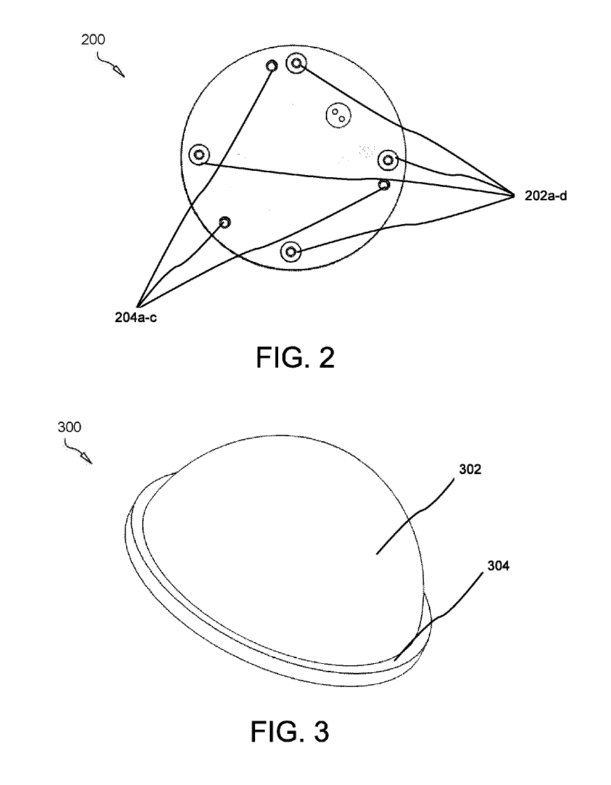

FIG. 2 is a lower perspective view of the base in accordance with the present invention. The base comprises a plurality of apertures 202, 204 for receiving threaded bolts. The base 102 may also comprise additional apertures for wires exiting or interconnecting the base 102 with a control box.

FIG. 3 is an elevational side perspective view of a convex lens in accordance with the present invention. While FIG. 3 illustrates a traditional plano-convex lens (i.e., a lens with one flat surface and one convex surface), it is appreciated that the current invention contemplates non-standard lenses that perform affect light transmissions similarly to plano-convex lenses.

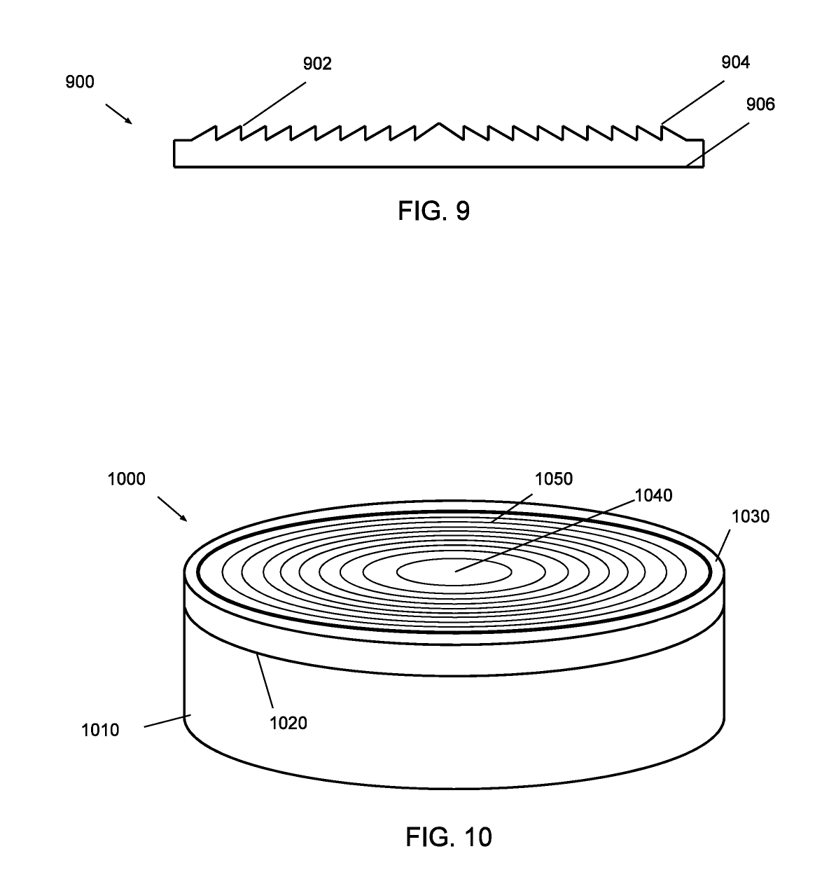

For example, in some embodiments, a Fresnel style lens may be utilized. As can be appreciated, utilizing a Fresnel style lens within light 100 would decrease the overall distance light 100 would extend away from its mounting location on the hull of a watercraft. This is because Fresnel style lenses utilize a series of concentric lens features that allow the reflective/refractive properties of a typical convex or concave lens to be achieved within a single plane. FIG. 9 includes a cross-sectional view of one configuration of a Fresnel style lens and will be discussed in detail below.

Generally, Fresnel lenses produce light output that is less optically sharp and consistent than a traditional convex lens. However, for the applications in which a light such as light 100 is typically utilized, diminished optical quality is less problematic.

On the other hand, the reduction in overall size that is possible by using a Fresnel may be highly beneficial. For example, as described previously, some embodiments of light 100 may be mounted to the side of a watercraft below the waterline. As previously described, such a mounting location will result in some amount of drag as the device travels through the water. Utilizing a Fresnel lens will reduce the overall size of the device which, alone, will reduce drag. Further, because the reduction in size occurs in the direction extending away from the hull, the drag reduction will be maximized.

Additionally, utilizing a Fresnel lens in conjunction with the illustrated retaining ring (e.g., retaining ring 114 of FIG. 1A) allows positioning of the lens entirely behind the retaining ring. In some embodiments, this is beneficial because it protects the lens by eliminating any portion of the lens that must extend beyond the retaining ring.

The focus lens 112 in convex from a top perspective view. The focus lens 112 comprises a flange 304 circumscribing the lens 112. In the preferred embodiment, the flange 304 and focus lens 112 are formed as a single integrated piece.

The focus lens 112 is disposed between the top surface of the base 102 and a bottom surface of an annular retaining ring 114.

The base 102 and retaining ring 114 may be fabricated from aluminum, stainless steel, titanium or other materials known to those of skill in the art.

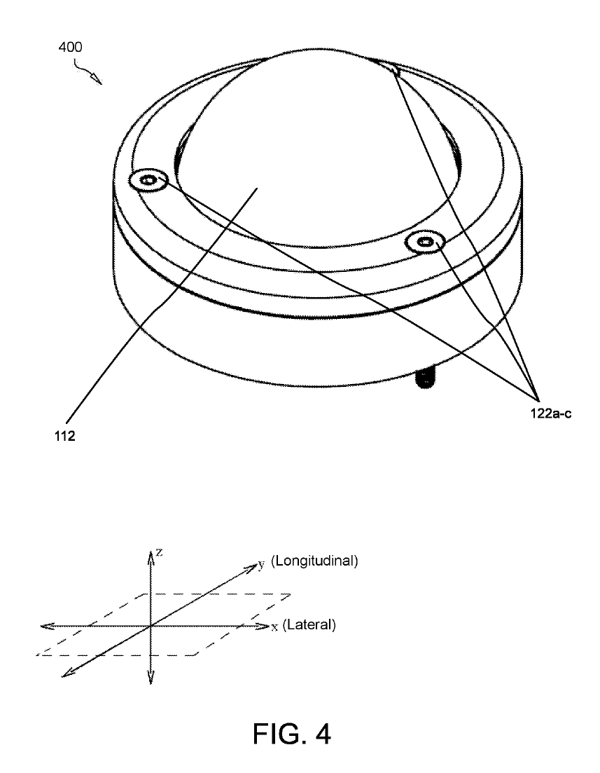

FIG. 4 is an elevational side perspective view of an assembled submersible marine lighting apparatus in accordance with the present invention.

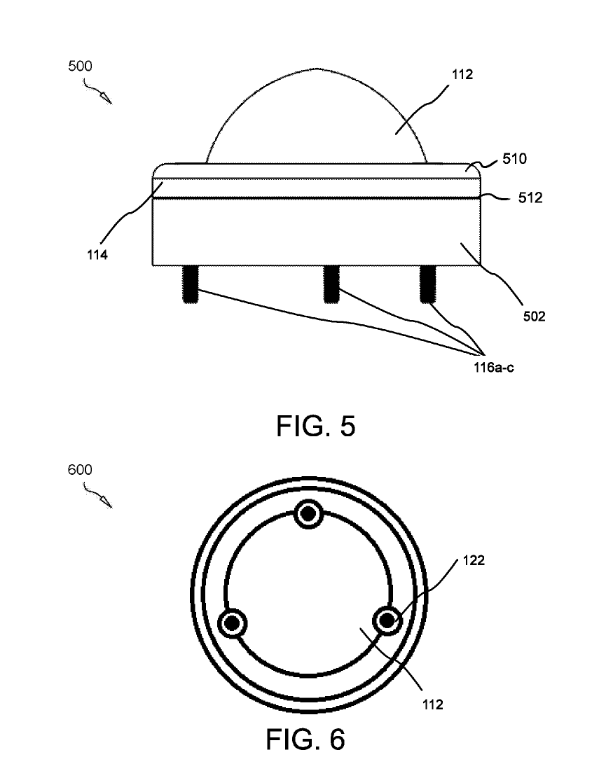

FIG. 5 is a side perspective view of an embodiment of a submersible marine lighting apparatus in accordance with the present invention. In this embodiment, some portions of light 500 (e.g., retaining ring 114), may be configured with a profile, such as chamfer 510, or another profile configured to aid in directing water away from seal 512. As one having ordinary skill in the art would recognize, based 502 may also be configured to include a profile that allows reduced drag forces to be exerted on light 100 when water runs across device.

As has been previously discussed, utilizing a Fresnel lens in conjunction with an embodiment, such as light 1000 of FIG. 10, dramatically reduces the profile of light 1000. Such a profile reduction is beneficial, in some embodiments, to reduce water drag, protect sensitive lens material (e.g., glass, plastic, or other suitable lens material), and potentially to reduce overall weight and mounting requirements for the light 1000.

As shown, the retaining ring 114 is mounted on the base 502 around the focus lens 112. A plurality of button head cap screws 116 insert into the base 102 through the hull of a ship or watercraft.

FIG. 6 is a top perspective view of a submersible marine lighting apparatus in accordance with the present invention showing flat head cap screws 112 and domed focus lens 112.

FIG. 7 is an exploded environmental side perspective view of a submersible marine light in accordance with the present invention.

The lights 400 may disposed alongside the hull of a boat 702 or on the stern below the waterline.

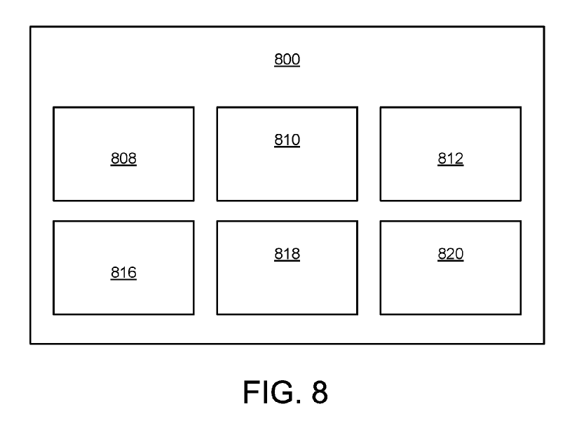

FIG. 8 is a block diagram of a fan box 800 for controlling input to a submersible light in accordance with the present invention. One having ordinary skill in the art would appreciate that the elements described within fan box 800 may be configured in any suitable manner to provide the functions of the illustrated components.

In some embodiments, fan box 800 is configured to be installed on the interior of the hull of a water craft and then electrically connected to a submersible light apparatus that is attached on the exterior of the hull below the waterline. In order to accomplish this, in some embodiments, electrically conductive wiring will pass through apertures created in the hull and then into the submersible light. For example, fan box 800 may be connected to submersible light 100 as shown in FIG. 1A or 1B. Further, as shown in FIG. 2, the electrical connection between fan box 800 and light 200 may be accommodated through access holes within the base of light 200 that provide an opening to then attach the wiring to a light array, such as LED array 118.

In various embodiments, fan box 800 may include a voltage up-converter with thermal protection, short circuit protection, and under voltage protection. In some embodiments, one or more of these components may alternatively be housed within the light assembly mounted on the exterior of the watercraft, for instance one or more of the components may be housed either in the recess defined by the base 102 or a separate fan-cooled housing 800 configured to be operable wirelessly. Regardless of the location of the individual components, each of the components is configured to maintain a suitable electrical connection such that each component is able to provide its intended function.

In some embodiments, fan box 800 includes a cooling fan that is operable to cool other components within fan box 800 that generate heat as a by-product of their function. In some embodiments, the fan may be a 92 mm cooling fan 810 as characterized by the diameter of the cooling element.

Fan box 800 is configured to be connected to the electrical system of the watercraft in which the box installed. For example, fan box 800 may be electrically connected to the battery of a watercraft.

In embodiments, the fan box may be configured to include a voltage up converter 816 to increase the voltage received from the electrical system of the watercraft to match the requirements of the submersible lighting apparatus. For example, voltage up converter 816 may be configured to receive a 12-volt input from the internal electrical system of the watercraft (e.g., from a 12-volt battery) and internally up convert the voltage for example to 24 volts nominal, 36 volts nominal, 48 volts nominal, 60 volts nominal, or even higher as necessary.

In various embodiments, fan box 800 comprises an extruded aluminum box. In other embodiments, fan box 800 is made from other suitable metals. Due to the internal functioning of certain components, the physical housing of fan box 800 may function to dissipate heat away from the internal componentry to improve reliability and maintain a safe operating temperature within the housing.

In some embodiments, fan box 800 includes a wireless transceiver connected to a master switch, such as mast switch 808. For example, wireless transceiver 812 is configured to receive wireless radio communications originating from outside of fan box 800 that function to activate fan box 800 and provide electrical power to the connected lighting apparatus.

In embodiments implementing wireless transceiver 812, a wireless fob 811 is also included. Wireless fob 818 is configured to transmit (and, in some embodiments, receive) radio signals to wireless transceiver 812 to activate certain functionality within fan box 800, such as turning fan box 800 on or off.

In some embodiments, wireless fob 818 is a small electronic device such as a key fob that is activated by a user of the watercraft remotely from fan box 800, for example, from the driver's seat of the watercraft. It is appreciated that wireless fob 818 may include various buttons, switches, or other physical characteristics that allow it to transmit commands to wireless transceiver 812 to perform corresponding functionalities.

In some embodiments, wireless fob 818 includes a master on function and a master off function that fully activates or deactivates, respectively, a lighting apparatus connected to fan box 800.

In other embodiments, wireless fob 818 and corresponding wireless transceiver may be connected to a function module 820 to enable more advance features. In some embodiments, function module 820 may be configured to selectively activate/deactivate one or more of several different lights attached to the hull of the watercraft.

In some embodiments, function module 820 may be configured to provide customized behaviors for multiple lights. For example, strobe, flash, dimming, colors, or other lighting features may be implemented.

In some embodiments, function module 820 may be configured to alter the functionality of attached lights based on their mounting location on the watercraft. For example, function module 820 may cause lights mounted on the starboard side of the hull to behave in one way while lights mounted to the port side of the hull behave another way. For example, in one embodiment, function module 820 causes lights on the starboard side of a watercraft to emit green light while lights on the port side emit red light.

FIG. 9 illustrates a cross-sectional view of one embodiment of a Fresnel style lens 900. The lens 900 includes a surface 906. The lens also includes a series of concentric rings including ring 902 and ring 904. Because lens 900 is shown in cross sectional view, the side elevation of each ring is visible. As is appreciated, each concentric ring, in this exemplary embodiment, includes an angled portion and a vertical portion. By configuring the rings in this manner, light may be reflected and/or refracted in a manner that produces light output similar to a traditional convex lens. However, as is also appreciated, the overall cross-sectional volume of lens 900 is greatly reduced as compared to a convex lens, for example lens 302 of FIG. 3. One having ordinary skill in the art would recognize that a Fresnel style lens may be produced that is capable of affecting light output in a manner that can be compared to many traditional convex lenses. This may be accomplished through varying the number of concentric rings, the width of the vertical portion, the width of the angled portion, the distance between the rights, or by other known methods.

It is also appreciated that surface 906 may be a top surface or a bottom surface depending on how the lens 900 is being utilized. For example, as will be discussed more fully in conjunction with FIG. 10, lens 900 may be oriented such that transmitted light first passes through the portion of lens 900 that includes the profiles of the concentric rings and then exits lens 900 at surface 906. In other embodiments, light may first pass through surface 906 and exit at the surface that includes the profiles of the concentric rings 902 and 904.

Turning now to FIG. 10, one embodiment of an assembled marine lighting apparatus 1000 is illustrated. Apparatus 1000 includes a base 1010 and a retaining ring 1030 that retains a lens 1040. As can be appreciated, lens 1040 includes concentric rings 1050 that correspond generally to the concepts discussed in conjunction with rings 902 and 904 of lens 900.

Apparatus 1000 also includes seal or gasket 1020 disposed between base 1010 and retaining ring 1030 and functions to provide a waterproof seal between the two components.

In one embodiment, lens 1040 is oriented in apparatus 1000 such that a flat surface of lens 1040 is exposed to the external environment. For example, as was discussed in conjunction with lens 900, lens 1040 may expose a flat surface similar to the surface 906. In the case of apparatus 1000, having a flat surface of a Fresnel style lens exposed to the external environment may be advantageous as compared to exposing the surface with the concentric ring profiles. For example, a flat surface may introduce less drag as the apparatus 1000 moves through the water. Additionally, a flat surface may be easier to clean (and keep clean) than a surface with significant profile variation. Additionally, a flat surface may be less affected by surface damage than the profiled surface.

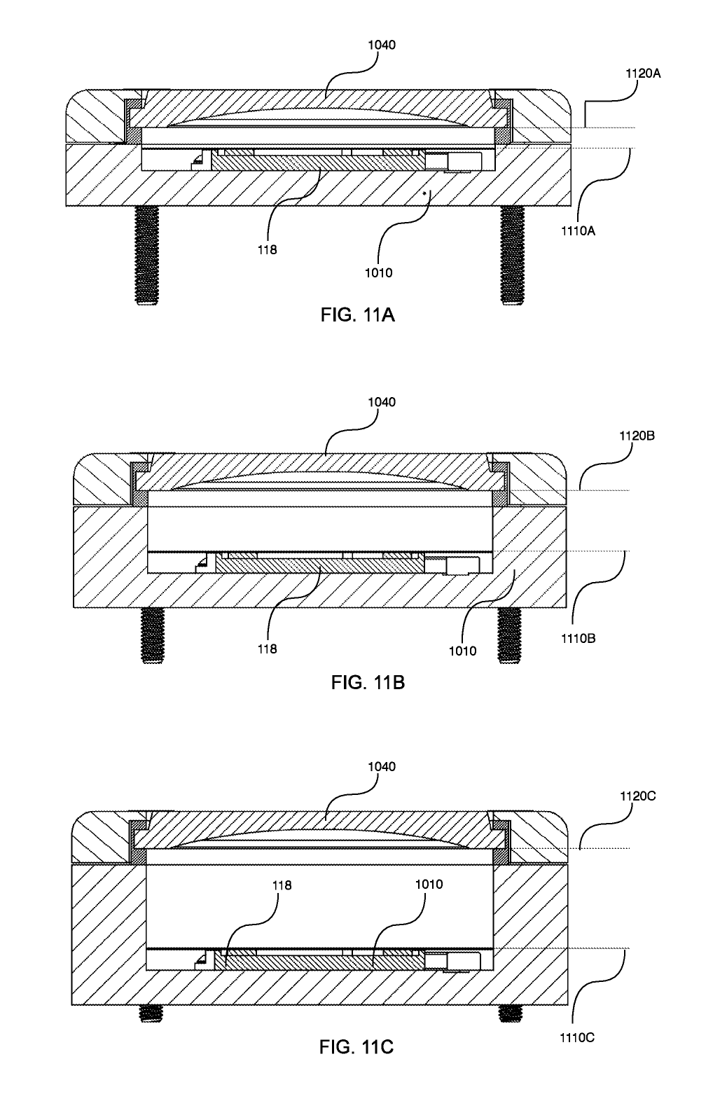

FIGS. 11A through 11C illustrate cross-sectional views of three embodiments of a marine lighting apparatus. For the sake of consistency, the various cross-sectional views may be understood as being three distinct embodiments of the apparatus 1000 of FIG. 10.

In FIG. 11A, a first cross sectional view is illustrated. The apparatus includes an LED array 118 corresponding to the LED array of FIG. 1B. The apparatus also includes a base 1010 and a lens 1040. It is appreciated that, as illustrated, lens 1040 is configured such that the non-profiled surface is exposed to the external environment as discussed previously.

Within FIG. 11A, two demarcation lines are also included and labeled 1110A and 1120A. It is appreciated that these demarcation lines are not physical components of the apparatus but are used to demarcate the location of the top 110A of LED array 118 and the bottom 1120A of lens 1040. It is also appreciated that because these two demarcation points are not at the same location, there is a distance between them. This distance corresponds to the offset distance discussed previously such as in conjunction with FIG. 1A and FIG. 1B.

In the embodiment of FIG. 11A, the distance between top 1110A and bottom 1120A is between 2 mm and 10 mm. As has been previously described, this distance will result in a generally wider transmission angle than will occur in the apparati discussed in conjunction with FIGS. 11B and 11C. Accordingly, FIG. 11A will produce a lower candela value than the other two configurations at a given lumen output.

Moving now to FIG. 11B, the distance between top 1110B and bottom 1120B is greater than between top 1110A and bottom 1120A. For example, in this embodiment, the distance may be between 8 mm and 20 mm. As has been previously described, this distance will result in a generally wider transmission angle than will occur in the apparatus discussed in conjunction with FIG. 11C but in a narrower transmission angle than that of FIG. 11A. Accordingly, FIG. 11B will produce a higher candela value than in FIG. 11A but a lower candela value than in FIG. 11 C at a given lumen output.

Moving now to FIG. 11C, the distance between top 1110C and bottom 1120C is greater than between top 1110A and bottom 1120A and between top 1110B and bottom 1120B. For example, in this embodiment, the distance may be between 15 mm and 30 mm. As has been previously described, this distance will result in a generally narrower transmission angle than that of FIGS. 11A and 11B at a given lumen output.

In Table 1 shown below, various calculations for the embodiments of FIGS. 11A through 11C are shown at particular exemplary values. It is appreciated, however, that the values chosen for Table 1 are illustrative only and other values consistent with this disclosure may be utilized with correspondingly different calculated outputs. With that said, particularly with respect to the chosen “Offset Value,” preferred values have been identified.

TABLE 1

| Lumen Output | Recess Diameter | | Offset Distance | | Candela Output |
|---|---|---|---|---|---|
| 1000 | 50 | mm | 2 | mm | 173 |
| 1000 | 75 | mm | 10 | mm | 214 |
| 1000 | 50 | mm | 8 | mm | 228 |
| 1000 | 75 | mm | 20 | mm | 292 |
| 1000 | 75 | mm | 15 | mm | 253 |
| 1000 | 150 | mm | 30 | mm | 253 |

As can be appreciated by the calculations of Table 1, various configurations of offset diameters (e.g., distances between the top of an LED array and the bottom of a lens surface) can be combined with different recess diameters to affect the candela output of an LED array. Notably, a smaller housing with a greater offset distance may produce higher candela output compared to a larger housing with less offset distance. In other configurations, such as comparing the second and third rows of TABLE 1, it is appreciated that a configuration with both narrower recess diameter and a shorter offset distance can produce similar (and even higher) candela output compared to a configuration with a wider recess diameter and longer offset distance (i.e., 214 candelas versus 228 candelas.)

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A submersible light comprising:
a circular base comprising a recess for receiving a light-emitting diode (LED) array;
an LED array, wherein an emitting surface of the LED array is positioned within the circular base such that the LED array is offset from a bottom surface of an optical lens;
the lens disposed between the circular base and a retaining ring configured to retain a flange circumscribing an optical lens, wherein the retaining ring is bolted to the base.

2. The submersible light of claim 1, wherein the offset distance is a known offset distance.

3. The submersible light of claim 2, wherein the known offset distance is between 2 mm and 10 mm.

4. The submersible light of claim 2, wherein the known offset distance is between 10 mm and 25 mm.

5. The submersible light of claim 2, wherein a diameter of the recess defined by the circular base is between 50 mm and 150 mm, a lumen output of the LED array is between 500 lumens and 1500 lumens, and the known offset distance is between 5 mm and 25 mm.

6. The submersible light of claim 1, wherein the LED array is thermally coupled to the circular base.

7. The submersible light of claim 1, wherein the optical lens is a plano-convex lens.

8. The submersible light of claim 1, wherein the optical lens is a Fresnel lens.

9. The submersible light of claim 1, wherein the recess within the circular base has a sidewall height of between 5 mm and 25 mm more than a total assembled height of the LED array.

10. The submersible light of claim 1, wherein the offset is adjustable using one or more mounting elements that secure the LED array to the circular base, wherein the one more mounting elements are configured to raise or lower the LED array within the circular base.

11. The submersible light of claim 1, further comprising
an external control box electrically connected between a power system of a watercraft and to the LED array, wherein the external control box includes a voltage up-converter configured to receive a voltage corresponding to the voltage of the power system of the water craft and output a higher voltage corresponding to a voltage requirement of the LED array.

12. The submersible light of claim 1, wherein the voltage up-converter receives power from the power system of the watercraft and outputs at least 24-volt nominal power.

13. The submersible light of claim 1, wherein the voltage up-converter receives power from the power system of the watercraft and outputs at least 36-volt nominal power.

14. A marine lighting system comprising:
a submersible portion mounted to the exterior of a hull of a watercraft below a waterline, the submersible portion comprising:
a circular base affixed to the hull, the circular base comprising a recess for receiving a light-emitting diode (LED) array;
an LED array, wherein an emitting surface of the LED array is positioned within the circular base such that it is offset from a bottom surface of an optical lens;
a thermal protection circuit; and
the lens disposed between the circular base and a retaining ring configured to retain a flange circumscribing an optical lens, wherein the retaining ring is bolted to the base and the flange provides a substantially waterproof seal between the retaining ring and the circular base.
a control portion electrically connected between an electrical system of the watercraft and the submersible portion, wherein the control portion is mounted to the interior of the hull of the watercraft, and wherein the control portion comprises:
a master switch;
a voltage upconverter;
a wireless transceiver; and
a wireless fob configured to transmit radio waves from the wireless fob to the wireless transceiver of the control portion, wherein upon sending an on command to the wireless receiver of the control portion, the wireless transceiver triggers the master switch to being transmitting electrical power from the control portion to the submersible portion.
